(19) United States
(12) Patent Application Publication
(10) Pub. No.: US 2026/0024410 A1
(43) Pub. Date: Jan. 22, 2026

(54) GAMING MACHINE AND METHOD WITH GROUP GAME FEATURE

(71) Applicant: Everi Games Inc., Austin, TX (US)

(72) Inventors: David Ulloa, Reno, NV (US); Juan Mariscal, Las Vegas, NV (US); Cydny Audia, Reno, NV (US); Scott Slomiany, Rolling Meadows, IL (US); Adam Stubitsch, Oak Park, IL (US); John Mendell, Atlanta, GA (US)

(73) Assignee: Everi Games Inc., Austin, TX (US)

(21) Appl. No.: 19/346,460

(22) Filed: Sep. 30, 2025

Related U.S. Application Data
(63) Continuation of application No. 18/904,049, filed on Oct. 1, 2024.
(60) Provisional application No. 63/543,058, filed on Oct. 7, 2023.

(51) Int. Cl. G07F 17/32

(52) U.S. Cl. CPC G07F 17/3258

(57) ABSTRACT

A gaming machine, system, method, and program product for controlling such are provided. A group of gaming machines in a system is operated under control of at least one electronic processor to perform a method. The method includes receiving a player game activation input at a selected gaming machine and obtaining a game result in response. The method determines if the game result is to be awarded a designated jackpot prize, and if not, presents the game result on a display system of the selected gaming machine, and if so, sends a message to a group controller for the group of gaming machines. Under control of the group controller, a set of eligible gaming machines in the group of gaming machines presents an initial display sequence of a jackpot game presentation in unison. Then, the selected machine is identified and displays a final sequence of the jackpot game presentation.

### CROSS REFERENCE TO RELATED APPLICATIONS

This application is a continuation of U.S. patent application Ser. No. 18/904,049, filed Oct. 1, 2024, entitled “GAMING MACHINE AND METHOD WITH GROUP GAME FEATURE,” which claims priority to U.S. Provisional Patent Application No. 63/543,058, filed Oct. 7, 2023, entitled “GAMING MACHINE AND METHOD WITH GROUP GAME FEATURE,” the entire contents of both of which are incorporated herein by reference.

### TECHNICAL FIELD OF THE INVENTION

The invention relates to gaming machines including group game features.

### BACKGROUND OF THE INVENTION

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated horse races in which wages may be placed.

Group games are used with slot machines to improve the variety of prizes and game playing experiences available. For example, some games provide that a bank of gaming machines enter a group bonus mode in which higher value prizes are awarded. Other games provide a group event that is similar to a tournament, in which high value prizes are awarded to certain individual gaming machines that obtain better results while wagering in the group mode. Group bonuses are often triggered by some event at one or more of the gaming machines in the group, while tournament style group games may be scheduled.

Game manufacturers are continuously pressed to develop new game presentations, formats, and game graphics in an attempt to provide high entertainment value for players and thereby attract and keep players. What is needed are ways to provide both anticipation and excitement to players while providing more variability in game results.

### SUMMARY OF THE INVENTION

A gaming machine, system, method, and program product for controlling such are provided. A group of gaming machines in a system is operated under control of at least one electronic processor to perform a method. The method includes receiving a player game activation input at a selected gaming machine of the group of gaming machines and obtaining a game result in response. The method determines if the game result is to be awarded a designated jackpot prize, and if not, presents the game result on a display system of the selected gaming machine, and if so, sends a message from the selected gaming machine via a group game messaging plugin to a group gaming mode messaging service at a group controller for the group of gaming machines indicating that the designated jackpot prize is to be awarded. Under control of the group controller, the method executes mode change control code to send state change messages to a set of eligible gaming machines in the group of gaming machines and the selected gaming machine, the state change messages including a state value and event data. The display systems of the set of eligible gaming machines and the selected gaming machine all display an initial sequence of a jackpot game presentation in response to the state change messages. Then, the selected machine is identified and its display system displays a final sequence of the jackpot game presentation.

An object of the present invention is to provide an improved software architecture for a group jackpot game presentation. Another object of the invention is to provide messaging services and control code for coordinating a group of machines to present a group jackpot game when a resulting winning machine is already known to the system.

According to additional aspects of the invention, a gaming machine and system include software program code for executing the method in cooperation between the gaming machines in the group and the group controller. The group controller includes a non-volatile storage device storing a group gaming mode messaging service, mode change control code, and EGM eligibility tracking code. Each gaming machine includes a non-volatile storage device storing a game engine and a game module, the game module comprising group gaming mode code and a group game messaging plugin. Each gaming machine further includes a messaging service executed by the game engine for communicating with the group gaming mode messaging service of the group controller. The messaging service at each gaming machine watches a message bus and, upon detecting a message from the group gaming mode messaging service, forwards the message to the group game messaging plugin. The group game messaging plugin is operable to receive messages from the messaging service and store event data from the messages in an event data storage accessible by the group gaming mode code.

Another aspect of the invention is a gaming system that includes one or more gaming servers, and a group of electronic gaming machines connected to the servers by a network, programmed to provide one or more of the methods described herein. The various functionality described herein may be distributed between the electronic gaming machines and the gaming servers in any practically functional way. For example, the current preferred architecture is for the servers to determine all aspects of game logic, random number generation, and prize awards. The servers may be special purpose gaming servers. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 shows two game screen diagrams illustrating a base game mode on two gaming machines according to some embodiments.

FIGS. 2-7 a sequence of game screen diagrams on the same two gaming machines, illustrating progression through a jackpot gaming mode according to some embodiments.

FIG. 8 shows a flow diagram of a process for operating a group of gaming machines according to some embodiments.

FIG. 9 is a perspective view of a gaming machine which is suitable for implementing the transmissive display update processes described herein.

FIG. 10 shows a hardware and logical block diagram of gaming machine according to some embodiments.

FIG. 11 illustrates in block diagram form a software and data structure design for electronic gaming machines and a group game mode messaging service according to some embodiments.

FIG. 12 is a system block diagram of a gaming system according to one embodiment of the present invention.

### DESCRIPTION OF REPRESENTATIVE EMBODIMENTS

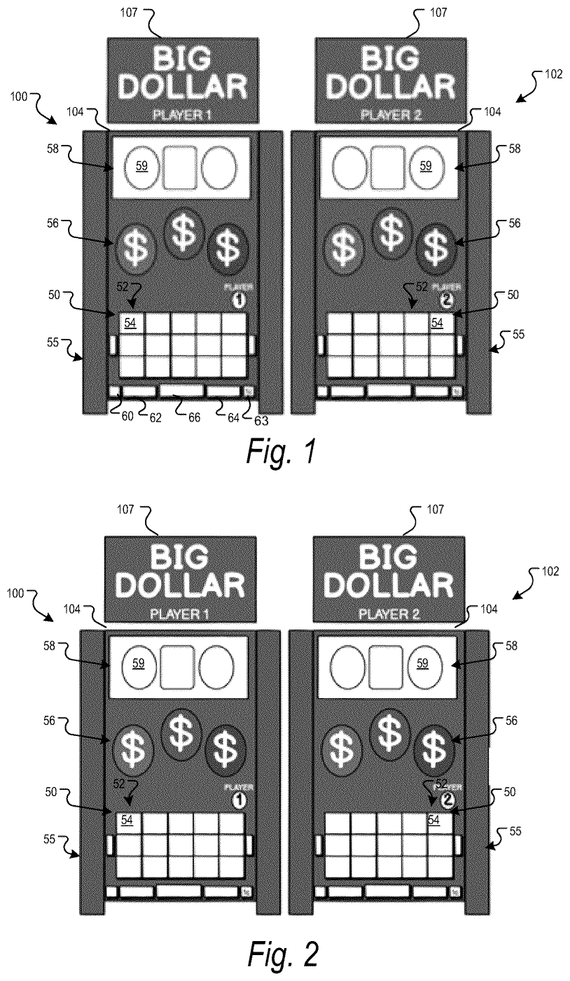

FIG. 1 shows of two game screen diagrams illustrating a base game mode on two gaming machines 100 and 102. For each gaming machine, the diagrams show a primary display 104 (“primary display”, “primary display area”) and atop, secondary display 107 to illustrate an example slot machine display arrangement on which wagering game results are presented in a gaming area, typically found on the primary display. Two secondary display areas 56 and 58 are present on primary display 104. Each gaming machine also includes a side display or LED panel 55 for providing graphics or lighting sequences.

The primary display area of a reel-type primary game (as opposed to jackpot games or other feature games as described herein) in this version is a matrix 50 of symbol locations 54 arranged in rows and columns to represent simulated slot machine reels that are spun to conduct a game round. Other embodiments may, of course, use other types of game displays to display randomizing of symbols according to the methods herein. The depicted columns of symbols labeled 52 represent the simulated reels, while symbols are shown in each symbol location designated 54. In this instance there are five reels with three symbol locations 54 displayed at a time on each reel, but the game can be played with more and less reels. The simulated reel typically has far more symbols than those displayed, and as many unique stop positions as there are symbols on the simulated reel. The stop position may be counted, for example, by numbering the symbols on the simulated reel and using the number of the symbol at the bottom of the display window (the three symbols displayed in this example), or at the top or middle. Further, while multi-symbol reels are shown, other versions may use simulated uni-symbol reels, or a reel that has many symbols thereon but only a single window to the reel simulated, displaying a single symbol from the reel. Some variations of the present invention may use a simulated uni-symbol reel in each depicted symbol location 54. Winning patterns are typically formed by matching symbols along defined paylines that pass through the matrix 50.

Secondary display area 58 is located toward the top of primary display 104 and the primary display area including matrix 50 is located toward the bottom of the display. Secondary display area 58 includes a number of symbol locations 59 which are employed for presenting a group jackpot game in this embodiment. Secondary display area 56 includes graphics such as symbols which are altered or animated to indicate activity in the group jackpot game as further described below with respect to FIGS. 2-7.

Below matrix 50 is box 60, which displays the current wager and amount bet per payline. Other versions may not have a designated bet per line. To the right of box 60 is box 62, which displays the current credits in the player's account. In the bottom center a touchscreen play button 66 is presented in the lower central area of the display, which may show other game state related graphics. Right of this is win box 64, which displays the player's last awarded winnings. The wager credit denomination is shown in box 63, which may reflect monetary value credits or non-monetary value credits such as player points.

FIGS. 2-7 show a sequence of game screen diagrams on the same two gaming machines, illustrating progression through a jackpot gaming mode according to some embodiments. The sequence depicts operation in a group gaming mode in which a group jackpot presentation is conducted at a group of gaming machines.

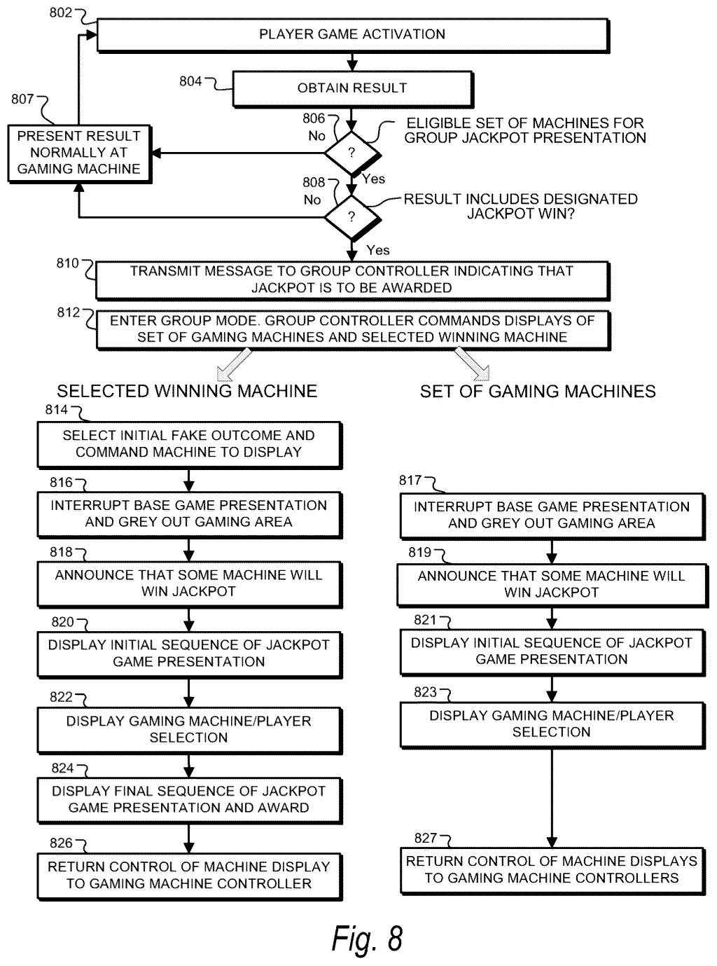

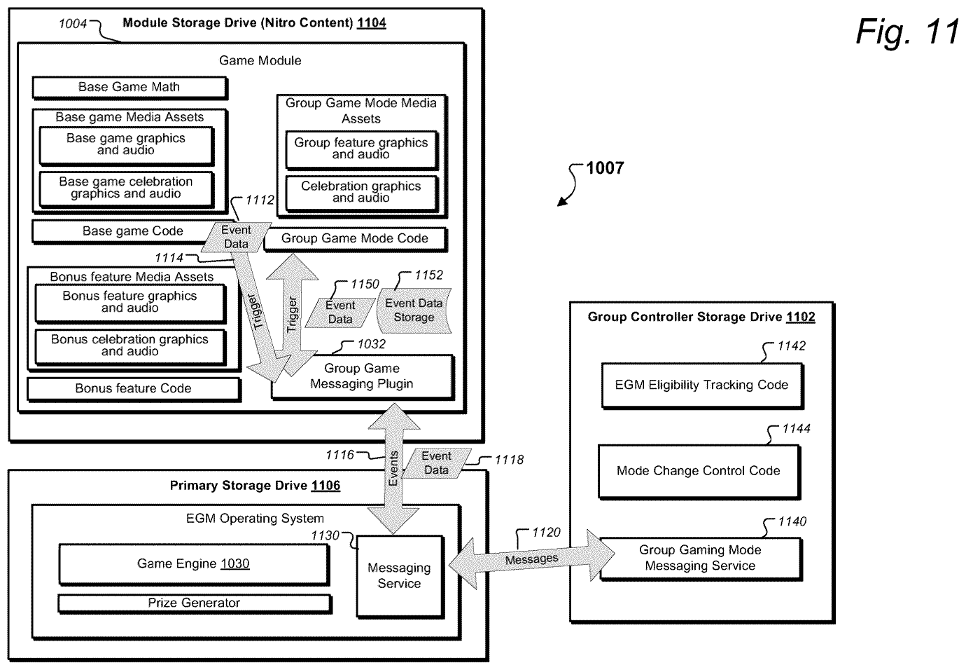

FIG. 8 shows a flow diagram of a process for operating a group of gaming machines according to some embodiments. The process is suitable for use with a group of gaming machines as described herein, or other suitable groups of gaming machines, and is suitable for use with a networked gaming system as described herein, or other suitable networked gaming systems. The process is described with reference to FIGS. 2-8, and is generally conducted under control of electronic processors in the gaming machine and a group controller, as further described below. To initialize the game and make it available for wagering, the process starts a game engine software package for executing game code like that depicted in FIG. 11, including loading data structures such as media assets.

The process begins at block 802 with a player game activation. This activation is made in a base gaming mode at a gaming machine within a group of gaming machines which are configured to act as a group with respect to a group jackpot game. For example, the group may be a “bank” of gaming machines, or a group of gaming machines located near each other on a gaming floor. In other embodiments, a group may include gaming machines that are not nearby other gaming machines in the group. Gaming activations typically occur repeatedly at all active gaming machines in the group, and each have a chance to participate in the group jackpot game.

At block 804, the process obtains a result for the game activation, typically by random generation or random selection from a result pool. The result has a chance for a group jackpot win. At block 806, the process checks if there is an eligible set of gaming machines in the group to participate in the group jackpot award and identifies the set of eligible gaming machines. Identifying a set of eligible gaming machines in the group of gaming machines typically includes identifying gaming machines that are in a coin in state at a designated denomination level. Identifying a set of eligible gaming machines in the group of gaming machines may also include identifying gaming machines from the group that meet a set of conditions including one or more of: the gaming machine is not conducting a bonus game; the gaming machine is not conducting a base game feature presentation; and the gaming machine is not in a free-spin mode. If there is an eligible group of gaming machines at block 806, the process continues to block 808. If not, the process goes to block 807 where it presents the game results normally at the gaming machine. In some possible scenarios, a jackpot prize due to a particular gaming machine that might otherwise result in a group jackpot presentation is awarded with a different presentation, that is not a group jackpot presentation, because all the other gaming machines in the group are currently ineligible to participate in the group game.

At block 808, the process determines if the result includes a jackpot win to be awarded a designated jackpot prize. Jackpot wins are preferably included in the randomly produced or randomly selected game result itself, including a tag indicating that a jackpot win is included in the game result and an associated jackpot prize amount. In some embodiments, the process may randomly determine if a jackpot prize is to be awarded based on a separately generated random number at block 808. If no jackpot win is included in the result, the process goes to block 807. If a jackpot win is included, the process goes to block 810.

At block 810, the process includes sending a message from the gaming machine at which the result was obtained to a group controller for the group of gaming machines indicating that the designated jackpot is to be awarded. Then starting at block 812, under control of the group controller, the process includes identifying a set of eligible gaming machines in the group of gaming machines and causing display systems of the set of eligible gaming machines and the selected gaming machine to all display an initial sequence of a jackpot game presentation in unison. The process is different on the gaming machine that obtained the winning outcome for the jackpot (referred to as the selected winning machine), as shown at blocks 814, 816, 818, 820, 822, 824, and 826, and the other gaming machines in the set, as shown at blocks 817, 819, 821, 823, and 827.

Referring to the selected winning machine, at block 814 the process may include, responsive to determining that the game result is to be awarded the designated jackpot prize, presenting an initial fake losing result at the selected gaming machine. This is preferably performed under control of the group controller by commanding the game presentation software at the selected winning machine to select and display the losing result. The purpose of this is to allow the jackpot prize to be presented consistently and synchronously inside the group jackpot presentation. In some scenarios or some embodiments, block 814 is not performed.

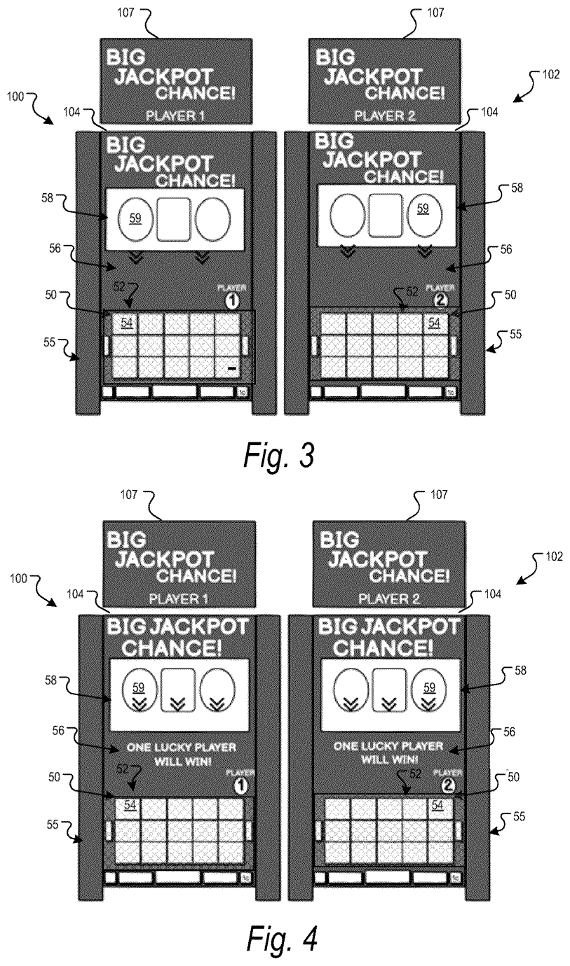

Then at blocks 816 and 817, in unison on the selected gaming machine and the set of gaming machines, the process includes interrupting the base game presentation and greying out the matrix of symbol locations (50, FIG. 3) to enter a group jackpot game presentation mode at the selected gaming machine and the set of gaming machines. The process provides a delay period in which base game spins are allowed to complete, but if a base game spin results in a bonus feature presentation, if such presentation is not completed with the delay period, the particular gaming machine involved will not be eligible for participation in the group jackpot presentation. When interrupted, the matrix may be removed or otherwise visually indicated to be inactive in other embodiments, but preferably a grey-out effect is used in which the area of matrix 50 is dimmed or covered in grey while inactive but still visible. Preferably, the general color scheme of on the selected gaming machine and the set of gaming machines is changed at blocks 816 and 817 to indicate a change in the gaming machines mode to a group jackpot presentation mode. As shown on FIGS. 3-6, this change of scheme preferably includes changing the color of side displays 55, changing the background color of secondary display 107, displaying a message on secondary display 107 such as the “Big Jackpot Chance” message shown in FIG. 3, and changing the background color of primary display 104. The group jackpot game presentation mode preferably includes adding an indicator on all gaming machines in the set (including the selected gaming machine) to identify them within the group, as exemplified by the “Player 1” and “Player 2” labels added to the sequence in FIG. 3. While two gaming machines are shown in the diagrams, all the gaming machines in the set are included. While in the depicted example the selected gaming machine which eventually is shown to win the jackpot prize is “Player 1”, this is just due to its position and the winning machine in the eligible set of machines participating in the group jackpot prize presentation may be identified with any label within the set. For example, the selected gaming machine may be “Player 3” or “Player 6”. The players may also be identified by name or player login rather than a number assigned to players. The ordering of the number is not relevant to the outcome and is preferably determined by each gaming machine's position in the group of gaming machines. The ordering may also be determined by gaming machine ID numbers or other suitable identifiers.

Next at block 818 and 819, the process makes an announcement on the selected gaming machine and the set of gaming machines that someone will win a jackpot prize. Preferably the announcement is made on the display, as shown int eh “ONE LUCKY PLAYER WILL WIN” announcement shown in FIG. 4 in secondary display areas 56, and audibly announcing through the audio system of each gaming machine, causing an audible announcement indicating that one of the gaming machines, or one of the players, will win a large prize or jackpot prize. This announcement is to ensure that the players understand why their gaming machine has changed modes, and that the change does not indicate that they have already won a jackpot.

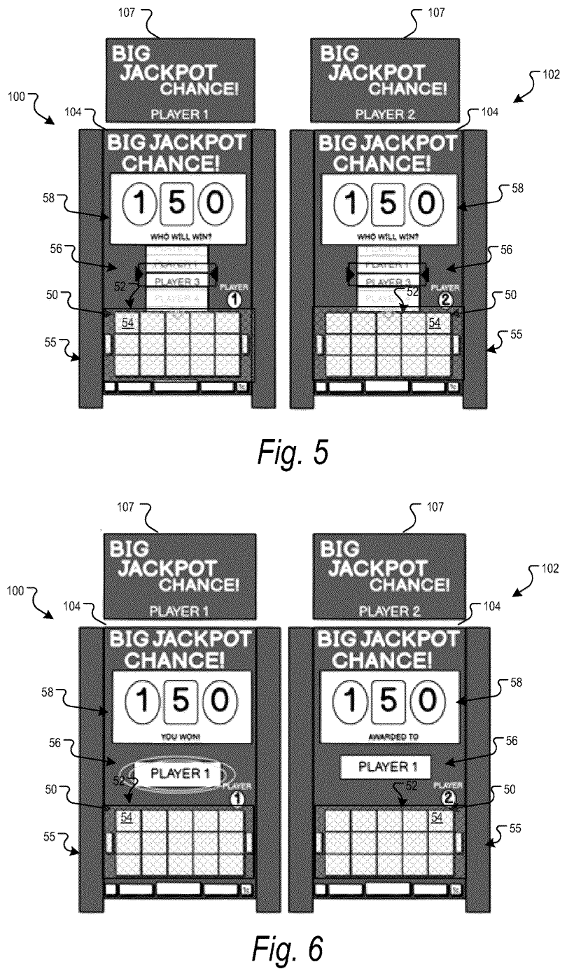

At blocks 820 and 821, the process displays an initial sequence of a group jackpot game presentation on the selected gaming machine and the set of gaming machines. This initial sequence includes the group controller causing the display systems of the selected gaming machine and the set of gaming machines to all display an initial sequence of a jackpot game presentation in unison. The presentation may include presenting a reel selection sequence separately on the selected gaming machine and each of the set of gaming machines including displaying an associated prize amount. An example of such an initial presentation sequence is shown in the sequence of FIGS. 3-5, where symbol locations 59 on secondary display area 58 are randomized by simulated spinning of unisymbol reels to produce a jackpot number amount. This is indicated by the downward arrows on FIG. 3 and FIG. 4. FIG. 5 shows a jackpot amount of “150” has been selected by the initial group jackpot game presentation. Although only two machines are shown, the initial presentation is shown on all the gaming machines in the set. Further, while a set of unisymbol reels are used to show in the initial presentation, other suitable game presentations may be used to present the group jackpot bonus, including presentations that do not directly show the award amount.

Next, at blocks 822 and 823, the process includes causing the selected machine to be identified by displaying a selection process in unison on the selected gaming machine and the set of gaming machines. Preferably, causing the selected machine to be identified comprises presenting a visual selection on display systems of the selected gaming machine and the set of gaming machines identifying the selected gaming machine or a player at the selected gaming machine. An example of this is shown in the sequence of FIG. 5-FIG. 6, in which a graphic presentation of a selection is shown in secondary display are 56. In this embodiment, the selection is depicted by a vertically spinning wheel with the gaming machines or players identified on the wheel, which stops to select the selected gaming machine, as shown by “Player 1” being selected in FIG. 6. The displayed selection is predetermined because the winning game outcome and gaming machine has already been determined by the winning outcome at block 808. Because the initial winning outcome at block 808 was not displayed directly, it allows a group presentation at the set of gaming machines to be conducted to increase player engagement and excitement.

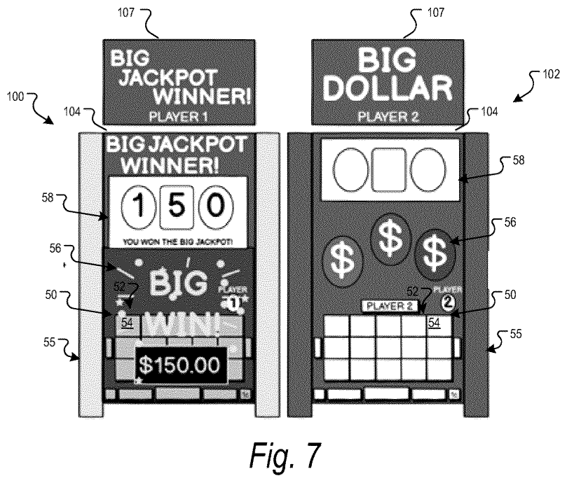

Next, at block 824, the process displays a final sequence of the group jackpot game by causing the selected machine to be identified and causing its display system to display a final sequence of the jackpot game presentation. As can be seen in the diagram, the final sequence is only displayed on the selected gaming machine, while the selected gaming machine is also identified on the gaming machines in the set of participating gaming machines. This display is depicted in FIG. 7 where the group jackpot prize is shown being awarded at the machine for Player 1, while the Player 2 machine does not include such a presentation.

Next at blocks 826 and 827, the process returns control of the gaming machine displays from the group controller to the individual gaming machine controllers. This return of control includes a change of mode from the group jackpot game mode to a base game mode. This return of control does not necessarily happen simultaneously at all the gaming machines involved, as illustrated in FIG. 7 where the machine for Player 2 is returned to its base game mode while the gaming machine for Player 1 is displaying the win presentation for the group jackpot prize.

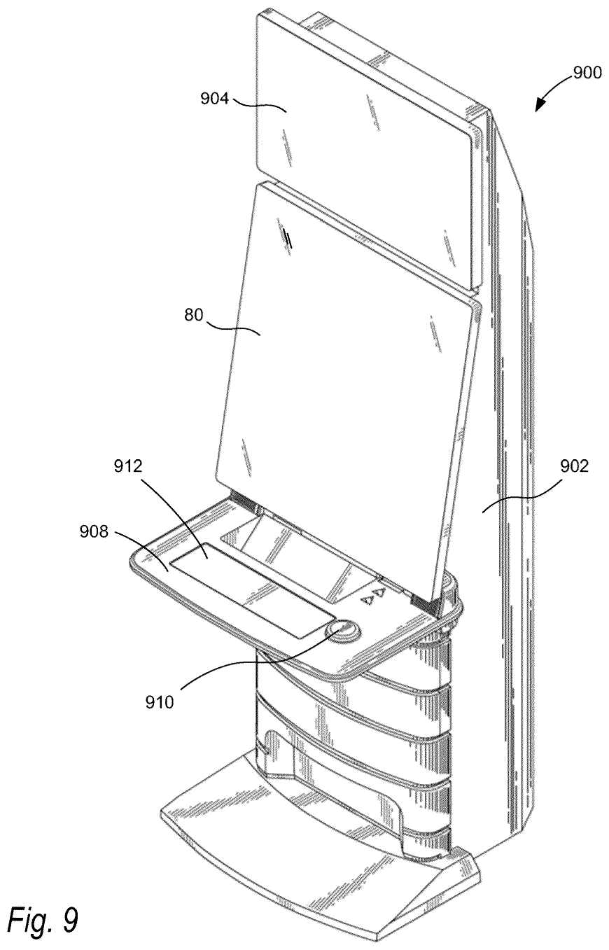

FIG. 9 is a perspective view of a gaming machine 900 which is suitable for implementing the transmissive display update processes described herein. Gaming machine 900 includes a cabinet 902 that houses various elements of the gaming machine. A front side of cabinet 902 supports an upper display device 904 and a lower display device 80. The front side of cabinet 902 also supports a button deck 908 that contains various player controls and interface devices including play button 910 and a touch screen button panel 912. As can be understood, in this embodiment, lower display device 80 provides primary game display 104, and upper display device 904 provides secondary display 107.

It will be appreciated that gaming machines may also include a number of other player interface devices in addition to devices that are considered player controls for use in entering inputs in the course of a particular game. For example, gaming machine 900 may include a currency/voucher acceptor, a voucher/receipt printer having a voucher/receipt printer, and a player card reader although these elements are not called out in FIG. 9. Numerous other types of player interface devices may be included in gaming machines that may be used to implement embodiments of the present invention.

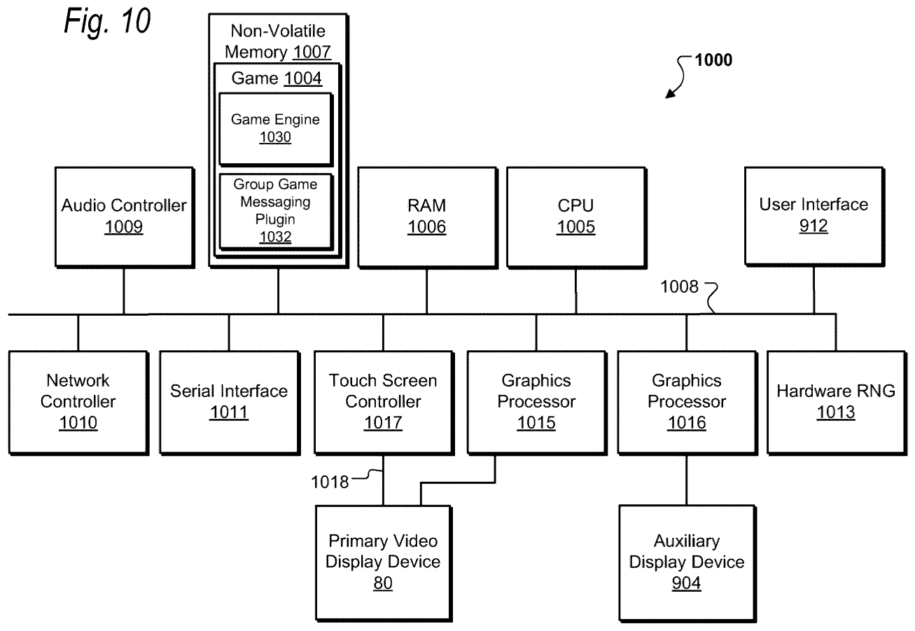

FIG. 10 shows a hardware and logical block diagram of gaming machine 1000 which includes a central processing unit (CPU) 1005 along with random access memory 1006 and nonvolatile memory or storage device 1007. The depicted design is suitable for implementing a gaming machine 900 (FIG. 9) or other similar gaming machines including mechanical reels behind a transmissive display and performing the mechanical reel prediction processes described herein. Gaming machine 1000 may embody a special purpose gaming machine including a hardware configuration approved by a regulatory gaming authority for use in casino gaming. Examples of such gaming authorities include the National Indian Gaming Commission (NIGC), the Arizona Department of Gaming, the California Bureau of Gambling Control, the California Gambling Control Commission, the Delaware Division of Gaming Enforcement, the Illinois Gaming Board, the Michigan Gaming Control Board, the Minnesota Alcohol and Gambling Enforcement Division, the Missouri Gaming Commission, the Nevada Gaming Commission, the Nevada Gaming Control Board, the New Jersey Casino Control Commission, the New Jersey Division of Gaming Enforcement, the New York State Gaming Commission, the Ohio Casino Control Commission, the Pennsylvania Gaming Control Board, the South Dakota Commission on Gaming, the Washington State Gambling Commission, and the West Virginia Lottery. Other similar non-U.S. gaming commissions may also approve such special purpose hardware.

The depicted devices are connected on a system bus 1008 with an audio controller 1009, a network controller 1010, and a serial interface 1011. A graphics processor 1015 is also connected on system bus 1008 and is connected to drive primary video display device 80 (mounted in cabinet 902 as shown in FIG. 9). A second graphics processor 1016 is also connected on system bus 1008 in this example to drive the auxiliary display device 904. Gaming machine 1000 also includes a touch screen controller 1017 connected to system bus 1008. Touch screen controller 1017 is also connected via signal path 1018 to receive signals from a touchscreen element associated with primary video display device 80. It will be appreciated that the touchscreen element itself typically comprises a thin film that is secured over the display surface of primary video display device 80. The touchscreen element itself is not illustrated or referenced separately in the figures, and is not used in some embodiments.

Those familiar with data processing devices and systems will appreciate that other common electronic components will be included in gaming machine 1000 such as a power supply, cooling systems for the various system components, audio amplifiers, and other devices that are common in gaming machines. These additional devices are omitted from the drawings so as not to obscure the present invention in unnecessary detail.

Generally, the hardware elements shown in FIG. 10 are known elements used in the gaming machine industry. These elements are preferably mounted in a computer chassis which is housed in cabinet 902 shown in FIG. 9. Alternatively, the various electronic components may be mounted on one or more circuit boards or modules housed within cabinet 902 without a separate enclosure. Those familiar with data processing systems and the various data processing elements shown in FIG. 10 will appreciate that many variations on this illustrated structure may be used within the scope of the present invention. For example, since serial communications are commonly employed to communicate with a touch screen controller such as touch screen controller 1017, the touch screen controller may not be connected on system bus 1008, but instead include a serial communications line to serial interface 1011, which may be a USB controller or a IEEE 1394 controller for example. It will also be appreciated that some of the devices shown in FIG. 10 as being connected directly on system bus 1008 may in fact communicate with the other system components through a suitable expansion bus. Audio controller 1009, for example, may be connected to the system via a PCI bus. System bus 1008 is shown in FIG. 10 merely to indicate that the various components are connected in some fashion for communication with game processor/CPU 1005 and is not intended to limit the invention to any particular bus architecture. Numerous other variations in the gaming machine internal structure and system may be used without departing from the principles of the present invention.

Although separate graphics processor 1015 is shown for controlling primary video display device 80, and graphics processor 1016 is shown for controlling both auxiliary display device 904, it will be appreciated that game processor/CPU 1005 may control all of the display devices directly without any intermediate graphics processor. The invention is not limited to any particular arrangement of processing devices for controlling the video display device included with gaming machine 1000. Also, a gaming machine implementing the present invention is not limited to any particular number of video display devices or other types of display devices.

In the illustrated gaming machine 1000, game processor/CPU 1005 executes software which ultimately controls the entire gaming machine including the receipt of player inputs and the presentation of the graphic symbols displayed according to the invention through the display devices 80 and 904 associated with the gaming machine. As will be discussed further below, game processor/CPU 1005 either alone or in combination with graphics processor 1015 may implement a presentation controller for performing functions associated with a primary game that may be available through the gaming machine, and may also implement a game client for directing one or more display devices at the gaming machine to display the feature game mode according to the present invention. Game processor/CPU 1005 also executes software related to communications handled through network controller 1010, and software related to various peripheral devices such as those connected to the system through audio controller 1009, serial interface 1011, and touch screen controller 1017. Game processor/CPU 1005 may also execute software to perform accounting functions associated with game play. Random access memory 1006 provides memory for use by game processor/CPU 1005 in executing its various software programs, while the nonvolatile memory or storage device 1007 may comprise a hard drive or other mass storage device providing storage for programs not in use or for other data generated or used in the course of gaming machine operation. Network controller 1010 provides an interface to other components of a gaming system in which gaming machine 1000 is included.

It should be noted that the invention is not limited to gaming machines employing the arrangement of processing devices and interfaces shown in example gaming machine 1000. Other gaming machines through which the features herein are implemented may include one or more special purpose processing devices to perform the various processing steps for implementing the present invention, such as generating random numbers or checking the security status of software packages or gaming credit vouchers. Unlike processing devices such as game processor/CPU 1005, these special purpose processing devices may not employ operational program code to direct the various processing steps.

Still referring to FIG. 10 showing an example design for a gaming machine 1000, the depicted machine in operation is controlled generally by game processor/CPU 1005 which stores operating programs and data in non-volatile memory or storage device 1007 with game software module 1004, and software or drivers for user interface 912, network controller 1010, audio/visual controllers, and a hardware random number generator (RNG) 1013, which is employed if software RNG procedures are not allowed in a particular gaming jurisdiction. Either hardware RNG 1013 or a suitable software RNG are employed for making the random selections of game outcomes, reel stop positions, etc. when operating the game as described herein.

The game software module 1004, once installed, also is held in non-volatile memory of the gaming machine, preferably a separate flash drive or hard drive from the memory holding the gaming machine operating system. CPU or game processor/CPU 1005 may comprise a conventional microprocessor, such as an Intel microprocessor, mounted on a printed circuit board with supporting ports, drivers, memory, software, and firmware to communicate with and control gaming machine operations, such as through the execution of code stored in non-volatile memory or storage device 1007. Such executed code includes a game software 1004 for executing one or primary game modules and includes software for controlling the graphical presentation of a virtual reel-based game in the matrix 50. In embodiments using a mechanical reel assembly to present the base game, the game software module includes software and firmware for controlling a mechanical reel presentation through a mechanical reel controller. Non-volatile memory 1007 also holds group gaming messaging plugin software or firmware 1032, which is executed by CPU 1005 to perform the interface processes and techniques described herein for providing control of the gaming machine display and audio system to the group controller for presenting the group jackpot award game, for example the process of FIG. 8. Game processor/CPU 1005 connects to user interface 912 such that a player may enter input information, and game processor/CPU 1005 may respond according to its programming, such as to apply a wager and initiate execution of a game.

Game processor/CPU 1005 also may connect through network controller 1010 to a gaming network, such as example casino server network 1100 shown in FIG. 11.

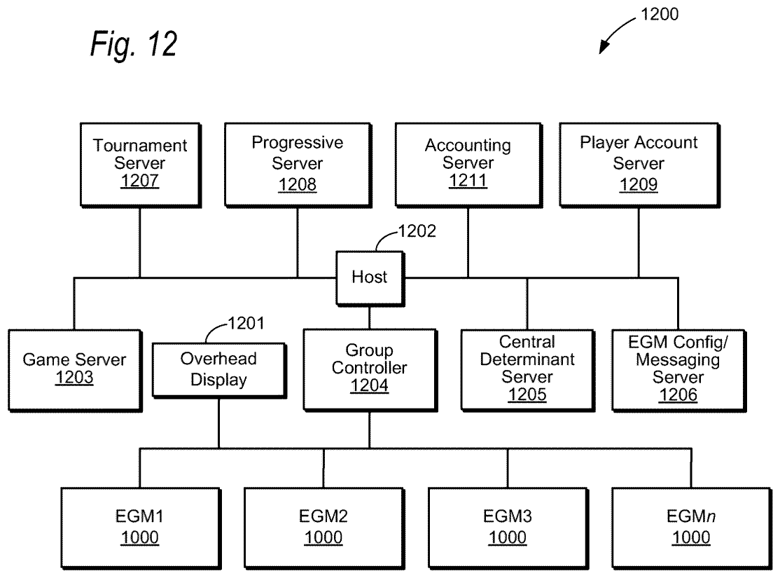

FIG. 11 illustrates in block diagram form a software and data structure design for electronic gaming machines and a group game mode messaging service according to some embodiments. Depicted are software elements that run on the gaming machine 1000 and group controller 1204 (FIG. 12), which coordinates the group presentation mode and directs the presentation at the group of gaming machines to perform the process of FIG. 8. The contents of non-volatile memory 1007 include contents of a module storage drive 1104, and a primary storage drive 1106. Also depicted are contents of a group controller storage drive 1102, which is a nonvolatile memory device of group controller 1204 (FIG. 12). Module storage drive 1104 and primary storage drive 1106 are reproduced at each of the electronic gaming machines in the group. The depicted modules on module storage drive 1104, primary storage drive 1106, and group controller storage drive 1102 are loaded into volatile memory and executed to perform the functions described herein.

Primary storage drive 1106 holds the EGM operating system and a game engine and may include a prize generator for producing randomized game outcomes, either with a random number generator or by request to a gaming outcome server such as central determinant server 405 (FIG. 8). In this embodiments, the game engine is the Nitro™ game engine provided by Everi Games, Inc., which interacts with a Nitro game server such as EGM Config/Messaging Server 1206 for managing installed games, and various Nitro messaging services for managing group presentations and group mode gaming such as tournaments, group gaming modes like those herein, and other group game presentations across multiple gaming machines.

Gaming module storage drive 1104, in this embodiment the Nitro Content drive, holds the software and data structures for providing particular games, embodied in a game module 1004. In this embodiment, game modules 1004 is added to separate module storage drive than the drive which stores EGM game engine, but this is not limiting, and other security measures may instead be used. This separated storage arrangement allows a configuration server to access the module storage drive for configuring the gaming machine.

Game module 1004 includes at least first data describing game math for describing the mathematical response to random numbers or randomly generated prizes provided by the prize generator. The base or primary game math data in module 1004 includes including bonus wager data and bonus payout data and definitions of the mathematical probabilities or operations to produce bonus game results based upon random numbers generated for game results. Game module 1004 also includes base game code for executing the logic and rules of the primary game, which is preferably script code executed by a script engine portion of game engine 1030, but may in other embodiments be another type of program code such as executable code executed directly by the EGM processor. Game module 1004 also includes base game media assets with digital media data including graphics and audio for all media features and sequences to be employed for executing the primary game results and any related media presentations such as the depicted bonus celebration graphics and audio.

Game module 1004 also includes bonus feature media assets and bonus feature code for executing bonus features such as bonus awards displayed in secondary display area 58, and respin awards, for example. Bonus features graphics and audio media are included and along with celebration graphics and audio for presenting bonus awards.

Also shown in game module 1004 are group gaming mode media assets and group gaming mode code. The media assets include the group gaming mode graphics and audio, such as the prize object graphics and animations for presenting the group award presentation described above. Celebration graphics and audio contain the media assets needed to present prize awards in the group gaming mode.

Game module 1004 includes group gaming mode code includes the executable code required to present the group gaming mode as described with respect to FIGS. 1-8. The group gaming mode code interacts with a messaging plugin to manage the activation and deactivation of the group gaming mode, and to track the prize objects 72 presented on the group game board through messaging with the group gaming mode messaging service plugin 203.

Game module 1004 also includes group game messaging plugin 1032, which interacts with group gaming messaging service 1130 for sending and receiving messages to perform the group game functions described herein. The messages may include event data as further described below. Group game messaging plugin also has access to event data storage memory 1152, which include volatile memory accessible by game module 1004 for storing event related data used by the base game code, the group game mode code, or the bonus feature code. The group gaming messaging plugin 1032 generally runs while base game code runs, and the bonus feature code and group game mode are activated by the base game code when necessary.

Group controller storage drive 1102 holds group gaming mode messaging service 1140, which is this embodiment is a Nitro messaging service communicating with EGMs 1000 in a designated group, using the Game to System (G2S) protocol, for coordinating the group gaming mode presentation as described herein. Group controller storage drive 1102 in this embodiment also includes EGM eligibility tracking code 1142 and mode change control code 1144. EGM eligibility tracking code 1142 performs the functions as described with respect to FIG. 8 for tracking EGMs in a group that are currently eligible for participation in a group gaming presentation, based on messages received through group gaming mode messaging service 1140. Mode change control code 1144 determines when to activate and deactivate the group gaming mode, and sends messages to manage the activation and deactivation to the set of gaming machines included in a group gaming mode as described herein.

In operation, mode change control code 1144 sends a periodic message to all EGMs that are configured to be in the group to track the set of gaming machine eligible to participate in the group jackpot game presentation described above, and to control the machines' synchronized presentation as described above. The period is set at a number of milliseconds or seconds, such as 500 milliseconds, 1 second, or 2 seconds, for example. The contents of the message include several variables containing event data:
State: Current state of the group jackpot game or other game for which a group presentation is made. When the mode change control code 1144 receives a “BankBonusTriggered” message from an EGM indicating that a group jackpot award has been triggered, a timed sequence of events will change the State value from the usual “NORMAL” to “QUEUE” then to “JACKPOT,” “SPIN”, and back to “NORMAL”. This is meant to be used for a synchronized sequence of events for presenting a group jackpot award presentation.
ActiveEGMs: number of EGMs that are in communication with mode change control code 1144 through the messaging service and in an “Active” state following a “EGMActive” or “EGMInactive” message from the EGM.
PlaysPerBet: Object containing the current number of spins played at each denomination and bet level combination. This object is updated whenever a periodic message is sent by the EGM to the mode change control code 1144.
JackpotPrize: Value in cents of the currently presenting group jackpot game presentation, sent with a “BankBonusTriggered” message.
JackpotStops: The reel stop positions that are meant to be used for the group jackpot game presentation of the currently awarded prize. Sent with a “BankBonusTriggered” message.
PlayerIDs: List of PlayerIDs that are currently in an “EGMActive” state.
TimeUntil: Ever decreasing millisecond timer value that counts from designated value such as four minutes since the last “BankBonusTriggered” message. After the TimeUntil has gone below zero, a new group jackpot prize event is made available to be triggered by a game result if the required number of eligible EGMs is met.
MarqueeMode: used to control a synchronized marquee light sequence across the group of gaming machines and overhead display 1201.

This event data is forwarded from messaging service 1130 to group game messaging plugin 1032, and may be stored in event data storage 1152. To accomplish this, messaging service 1130 at game engine 1030 watches the G2S message bus and upon detecting a message with the application ID of the active base game, triggers a bound processing function which propagates that message and data to group game messaging plugin 1032 as a message received. The group game messaging plugin receives the message and may convert it into a game event and, if applicable, a more consumable data structure in event data storage 1152 for use by the base game code or the group game mode code. The data, if there is any on the message, is then saved in event data storage 1152 so that the rest of the code in game module 1004 can access it. Games can then emit a game specific event to trigger game side functionality for various phases of the group jackpot game presentation, which will utilize the cached data as further described below.

In response to the periodic message, all EGMs connected to the group will respond with a response message. The contents of this response message are as follows:
hasPlayerID: Boolean value used to determine whether the EGM has its Player number that is displayed on the screen above the reels.
objPlays: Object containing the spins played at each Denom and Bet combination since the last periodic response was sent.

The group controller will then use this response message to restart a timeout timer to keep track of EGMs that are actively connected and communicating with the group controller. The group controller assigns and managers PlayerIDs as the machines become active, and keeps track of EGMs with a PlayerID that are “Active” and “Inactive” for the group jackpot bonus. The status of EGMs activity is changed through “EGMActive” and “EGMInactive” messages that are sent by the EGM during certain points in gameplay. In this embodiment, an EGM will become “Active” by being cashed in and in the base game. An EGM becomes “Inactive” whenever it enters its own dedicated bonus or when credits are cashed out of a machine. These messages are used to determine eligible machines in the process of FIG. 8.

Data sent through the periodic message will be read by the EGM that is receiving it. This data is used to check the criteria for allowing a group jackpot prize event to be triggered through the group of gaming machines. These values include a minimum number of active EGMs that are eligible to participate in the group jackpot presentation, and a minimum time since the last group jackpot presentation. Once these values have exceeded their thresholds, the base game code will configure the prize generator code of the game engine with values for determining if the group game jackpot is available. In this embodiment, the values include number value providing a minimum jackpot prize threshold for current number of active EGMs. For example, a lower jackpot prize value might be allowed to trigger for a lower number of active EGMs. The chance of triggering through the prize generator is also adjusted based on the current denomination and bet level at each gaming machine, with different chances of triggering available based on the number of active EGMs for different denomination and bet levels.

When the prize generator math for a randomized base game result returns a group jackpot prize, a “BankBonusTriggered” message is sent to the group controller as shown at trigger event 1114 to start the timed sequence of events that will present group jackpot game across the bank of EGMs connected to the group controller and eligible, for example as described with respect FIGS. 1-8. This trigger is forwarded through messaging service 1130 to group gaming mode messaging service 1140 mode change control code 1144.

The timed sequence starts with a QUEUE period designed to give the participating EGMs time to finish any in process base game plays so they can be entered into the group jackpot prize presentation. This QUEUE period occurs during blocks 810-814 of the process of FIG. 8, as can be seen there the selected winning machine may display a fake outcome during this period, while the other gaming machines of the set of gaming machines have the QUEUE period available before block 817 to finish base game presentations so that their base game display can be interrupted to start the group jackpot bonus presentation. A fake outcome is presented by the selected winning machine group game mode code activating such an outcome for responsive to the event message from group game messaging plugin 1032 entering the QUEUE period. During the QUEUE period, the participating EGMs will begin to have graphic effects such as flying stars on the edge of their screens while waiting for the next state. These graphic effects are activated by the group game mode code in response to the message from group game messaging plugin 1032 entering the QUEUE period, displaying media objects stored in the group feature graphics and audio. The QUEUE period preferably lasts for a predetermined period, 6 seconds in this embodiment.

The next sequence is the JACKPOT period, used for a synchronized presentation introduction to the group jackpot presentation. In the example process of FIG. 8, this period implements blocks 816, 817, 818, and 819. To implement this functionality, when mode change control code 1144 sends a message changing the state to the JACKPOT value to the set of gaming machines, messaging service 1130 these machines forwards this message to its respective group game messaging plugin 1032. The relevant data values are stored in event data storage 1152 recognized by the group game mode for controlling the JACKPOT presentation. In response to the state change to the JACKPOT period, the group game mode code is executed on the respective gaming engines 1030 to control the graphics processor of each gaming machine to present the announcement and initial graphic sequence of the group jackpot game presentation, for example as described with respect to blocks 818 and 819 of FIG. 8. This presentation also employs media objects stored in the group feature graphics and audio. The JACKPOT period preferably lasts for a predetermined period, 10 seconds in this embodiment.

The last sequence is the SPIN period, used to synchronize a reel spin display on the group of gaming machines in a synchronized fashion, for example as shown in blocks 822, 823, and 824. triggered prize shown. This period, like the others, is started with a message changing the State value, which Once the reels have stopped and shown the awarded prize, a vertically scrolling wheel will present and spin to show the winning player. Once the wheel stops, the winning player will be shown. The winning player will present a win while the losing players will be transitioned back to the base game. These graphic effects are activated by the group game mode code in response to the message from group game messaging plugin 1032 entering the SPIN period, and activates media objects stored in the group feature graphics and audio. The media objects include the reels in secondary display area 58 and in secondary display are 56 as shown in the embodiment of FIG. 5-6. Event data storage 1152 contains the variable data as listed above which is accessed by group game mode code and fed as parameters to the reel data objects to configure their outcomes.

The process functionality as described herein is controlled by the system processor by executing program code, executable by a gaming machine or group controller 1204, to accomplish the functionality as described herein. It should be understood that this is only one example embodiment, and other versions may divide the processing tasks of the game method in a different manner. For example, some systems may employ a thin client architecture in which practically all of the processing tasks are performed at the game server, and only display information for the player interface transmitted to the electronic gaming machine. In such an embodiment, only the steps involving player input or display are performed by the electronic gaming machine, with the remaining steps performed by one of the game servers in the system. In such a case, though, the software architecture is preferably designed as a thin client in which a dedicated virtual machine running on the game server (or a virtual machine server connected in the gaming network) performs the tasks designated in the present drawing as occurring “at the gaming machine.” In the depicted flowcharts, the method is performed by the respective computer hardware operating under control of computer program code. While central processor arrangements may vary (for example award controllers may be integrated on the same machine with a gaming server, or may be a separate server connected on a secure network), the particular central determinant architecture is not limiting and will be referred to generally in this drawing as the game server (403). To perform the base game and group gaming mode of FIG. 8, the thin client version of the process, performed at the game server, further includes receiving game play requests originating from electronic gaming machine, and sending commands to the gaming machine to show reels spinning, the graphical accumulation object, the bonus round selection process, and results being displayed. The division of game logic steps between gaming machines and servers is known in the art and may be accomplished according to suitable methods allowed for the relevant gaming jurisdictions.

Referring now to FIG. 12, a networked gaming system 1200 associated with one or more gaming facilities may include one or more networked gaming machines 100 (shown in FIG. 12 as EGM1-EGMn) connected in the network by suitable network cable or wirelessly. Networked gaming machines 1000 and one or more overhead display devices 1201 may be operatively connected so that the overhead display device or display devices may mirror or replay the content of one or more displays of gaming machines 1000. For example, the display content for a given gaming machine 1000 (including a base game portion and/or bonus features) may be transmitted through network controller 1010 to a controller associated with the overhead display device(s) 1201. In the event gaming machines 1000 have cameras installed, the respective player's video images may be displayed on overhead display device 1201 along with the content of the player's gaming machine display.

The example gaming network 1200 shown in FIG. 12 includes a host server 1202 and group controller 1204, that together may function as an intermediary between floor devices such as gaming machines 1000 and back-office devices such as the various servers described below. Game server 1203 may provide server-based games and/or game services to network connected gaming devices such as gaming machines 1000. Group controller 1204 performs functions for group control of the group jackpot game presentation as described above with respect to FIG. 8, by communicating with the group messaging plugin in each of gaming machines EGM1-EGMn to take control of their displays and audio systems, and controls graphic presentations on overhead display 1201. Generally group controller 1204 may receive messaging from gaming machines EGM1-EGMn to determine their eligibility to participate in the group jackpot game, including receiving messages indicating their wager denomination, and when they start and end game presentations such as bonus games and free spin games that determine eligibility to participate in a group jackpot game presentation as described with respect to block 806 (FIG. 8). Group controller 1204 may maintain an eligible list of gaming machines based on such messaging so that, when a group jackpot game presentation process such as that depicted in FIG. 8 is triggered, the group controller is ready to begin the group jackpot game presentation. Central determinant server 1205 may be included in the network to identify or select lottery, bingo, or other centrally determined game results and provide the result information to networked gaming machines 1000 that present the games or game results to players.

EGM configuration and messaging server 1206 may provide game and non-game content and operational software for use by the gaming machines 1000 in the course of providing games and while the gaming machines are unused and in an idle state. For example, server 1206 may control the distribution of game software and graphic control assets to the gaming machines as well as advertising messages and other messages that may be presented using a display device of a gaming machine 1000. EGM configuration and messaging server 1206 may also be used to direct candle control software to gaming machines 1000 that include a system in accordance with aspects of the present invention.

Tournament server 1207 may be included in the system for controlling or coordinating tournament functions. These functions may include maintaining tournament player scores and ranking during the course of tournament play, and communicating this information to the various gaming machines 1000 participating in the tournament. Tournament server 1207 may also function to enroll players in tournaments, schedule tournaments, and maintain the time remaining in the various tournaments.

Progressive server 1208 may maintain progressive pools for progressive games that may be available through the various gaming machines 1000, including the group jackpot awards described herein. In some implementations, progressive server 1208 may simply receive communications indicating contribution amounts that have been determined by processes executing at the various gaming machines 1000 or elsewhere in the gaming network. Alternatively, progressive server 1208 may perform processes to determine the contribution amounts for incrementing the various progressive pools that may be maintained. Progressive server 1208 may also periodically communicate current pool values back to the various gaming machines 1000 and may participate in communicating awarded progressive prize amounts to the gaming machines and in adjusting the progressive prize pools accordingly. In some implementations, progressive server 1208 may also determine or participate in determining when a progressive prize triggering event occurs.

Accounting server 1211 may receive gaming data from each of the networked gaming devices, perform audit functions, and provide data for analysis programs. Player account server 1209 may maintain player account records, and store persistent player data such as accumulated player points and/or player preferences (for example, game personalizing selections or options).

Gaming network 1200 illustrated in FIG. 12 is provided merely as an example of a gaming network that may include gaming machines with candle systems according to aspects of the present invention and is not intended to be limiting in any way. Gaming machines controlled according to aspects of the present invention are not limited to use with gaming networks such as network system 1200.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of the invention, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A method of operating a group of gaming machines under control of at least one electronic processor, the method comprising:
receiving a player game activation input at a selected gaming machine of the group of gaming machines and obtaining a game result in response;
determining if the game result is to be awarded a designated jackpot prize, and if not, presenting the game result on a display system of the selected gaming machine, and if so:
sending a message from the selected gaming machine via a group game messaging plugin to a group gaming mode messaging service at a group controller for the group of gaming machines indicating that the designated jackpot prize is to be awarded;
under control of the group controller, executing mode change control code to send state change messages to a set of eligible gaming machines in the group of gaming machines and the selected gaming machine, the state change messages including a state value and event data;
causing display systems of the set of eligible gaming machines and the selected gaming machine to all display an initial sequence of a jackpot game presentation in response to the state change messages; and
then, causing the selected machine to be identified and causing its display system to display a final sequence of the jackpot game presentation.

2. The method of claim 1, wherein the state change messages are sent from the group gaming mode messaging service to a messaging service at each of the gaming machines, and forwarded to the group game messaging plugin at each of the gaming machines.

3. The method of claim 1, wherein the state change messages include a sequence of state values comprising a queue state value for providing a delay period for gaming machines to complete in-process game presentations, a jackpot presentation state value for initiating a synchronized jackpot presentation, and a selection state value for displaying a selection of the selected gaming machine.

4. The method of claim 1, wherein the event data includes a jackpot prize value and reel stop positions for the jackpot game presentation.

5. The method of claim 1, wherein the group controller executes EGM eligibility tracking code to track gaming machines in the group that are currently eligible for participation in the jackpot game presentation.

6. The method of claim 5, wherein the mode change control code sends periodic messages to gaming machines in the group of gaming machines and receives periodic response messages from the gaming machines, and wherein the EGM eligibility tracking code identifies the set of eligible gaming machines based on information in the periodic response messages.

7. The method of claim 6, wherein the periodic response messages include data indicating game plays at each denomination and bet level combination.

8. A gaming system comprising:
a group of gaming machines each comprising a cabinet, a video display system attached to the cabinet, at least one player input device, and at least one electronic controller coupled to the at least one player input device and the video display system and programmed for operating a game;
a group controller coupled to the group of gaming machines over a network, the group controller including at least one electronic controller programmed to selectively control the video display systems of the group of gaming machines;
wherein the group controller includes a non-volatile storage device storing a group gaming mode messaging service, mode change control code, and EGM eligibility tracking code;
wherein each of the gaming machines includes:
a non-volatile storage device storing a game engine and a game module, the game module comprising group gaming mode code and a group game messaging plugin;
a messaging service executed by the game engine for communicating with the group gaming mode messaging service of the group controller;
wherein each of the gaming machines is operable for receiving a player game activation input at a selected gaming machine of the group of gaming machines and obtaining a game result in response, determining if the game result is to be awarded a designated jackpot prize, and if not, presenting the game result on a display system of the selected gaming machine, and if so, sending a message via the group game messaging plugin to the group gaming mode messaging service indicating that the designated jackpot prize is to be awarded; and
wherein the group controller is operable for executing the mode change control code to send state change messages to a set of eligible gaming machines in the group of gaming machines and causing display systems of the set of eligible gaming machines and the selected gaming machine to all display an initial sequence of a jackpot game presentation, then, causing the selected machine to be identified and causing its display system to display a final sequence of the jackpot game presentation.

9. The gaming system of claim 8, wherein the messaging service at each gaming machine watches a message bus and, upon detecting a message from the group gaming mode messaging service, forwards the message to the group game messaging plugin.

10. The gaming system of claim 9, wherein the group game messaging plugin is operable to receive messages from the messaging service and store event data from the messages in an event data storage accessible by the group gaming mode code.

11. The gaming system of claim 10, wherein the event data comprises a state value, a count of active gaming machines, jackpot prize information, and player identification data.

12. The gaming system of claim 8, wherein the EGM eligibility tracking code tracks gaming machines in the group that are currently eligible for participation in the jackpot game presentation based on messages received through the group gaming mode messaging service.

13. The gaming system of claim 8, wherein the mode change control code sends state change messages including state values comprising a queue state value for providing a delay period for gaming machines to complete in-process game presentations, a jackpot presentation state value for initiating a synchronized jackpot presentation, and a selection state value for displaying a selection of the selected gaming machine.

14. The gaming system of claim 8, wherein the non-volatile storage device of each gaming machine comprises a module storage drive holding the game module separate from a primary storage drive holding the game engine.

15. One or more tangible, non-transitory computer readable media holding instructions executable by at least one electronic processor of a gaming machine and a group controller for:
receiving a player game activation input at a selected gaming machine of a group of gaming machines and obtaining a game result in response;
determining if the game result is to be awarded a designated jackpot prize, and if not, presenting the game result on a display system of the selected gaming machine, and if so:
sending a message via a group game messaging plugin at the selected gaming machine to a group gaming mode messaging service at a group controller for the group of gaming machines indicating that the designated jackpot prize is to be awarded;
under control of the group controller, executing mode change control code to send state change messages to a set of eligible gaming machines in the group of gaming machines and the selected gaming machine;
executing group gaming mode code at the set of eligible gaming machines and the selected gaming machine to cause display systems to all display an initial sequence of a jackpot game presentation in response to the state change messages; and
then, causing the selected machine to be identified and causing its display system to display a final sequence of the jackpot game presentation.

16. The one or more tangible, non-transitory computer readable media of claim 15, wherein the instructions are further executable for executing a messaging service at each gaming machine to receive the state change messages from the group gaming mode messaging service and forward the state change messages to the group game messaging plugin.

17. The one or more tangible, non-transitory computer readable media of claim 16, wherein the instructions are further executable for executing the group game messaging plugin to store event data from the state change messages in an event data storage, and wherein the group gaming mode code accesses the event data from the event data storage to configure the jackpot game presentation.

18. The one or more tangible, non-transitory computer readable media of claim 15, wherein the instructions are further executable for executing EGM eligibility tracking code at the group controller to track gaming machines that are currently eligible for participation in the jackpot game presentation.

19. The one or more tangible, non-transitory computer readable media of claim 18, wherein the instructions are further executable for:
the mode change control code sending periodic messages to gaming machines in the group; and
the gaming machines sending periodic response messages to the group controller;
wherein the EGM eligibility tracking code identifies the set of eligible gaming machines based on the periodic response messages.

20. The one or more tangible, non-transitory computer readable media of claim 15, wherein the state change messages include state values comprising a queue state value for providing a delay period for gaming machines to complete in-process game presentations, a jackpot presentation state value for initiating a synchronized jackpot presentation, and a selection state value for displaying a selection of the selected gaming machine, and wherein each state value causes execution of different portions of the group gaming mode code.
